(19) United States
(12) Patent Application Publication
(10) Pub. No.: US 2025/0343377 A1
(43) Pub. Date: Nov. 6, 2025

(54) PLUG CONNECTOR AND RECEPTACLE CONNECTOR

(71) Applicant: LS MTRON LTD., Anyang-si (KR)

(72) Inventors: Su Chan LEE, Anyang-si (KR); Hyun Woo LEE, Anyang-si (KR); Jung Hoon CHOI, Anyang-si (KR)

(21) Appl. No.: 19/226,359

(22) Filed: Jun. 3, 2025

Related U.S. Application Data
(63) Continuation of application No. PCT/KR2024/001824, filed on Feb. 7, 2024.

(30) Foreign Application Priority Data
Feb. 8, 2023 (KR) 10-2023-0016623
Nov. 16, 2023 (KR) 10-2023-0159137
Feb. 5, 2024 (KR) 10-2024-0017370

(51) Int. Cl. H01R 13/6581; H01R 12/71; H01R 13/6591

(52) U.S. Cl. CPC H01R 13/6581; H01R 12/716; H01R 13/6591

(57) ABSTRACT

A plug connector, a receptacle connector, and a connecting are provided, in which the plug connector and receptacle connector according to the present disclosure have a plug shielder and a receptacle shielder to shield plug contacts and receptacle contacts from external noise, and pursue the stable coupling of the plug shielder and the receptacle shielder to power area portions in which power contacts are installed while having checking windows for checking states of soldering with circuit boards.

### CROSS-REFERENCE TO RELATED APPLICATION

This application is a Continuation Application of International Application No. PCT/KR2024/001824 filed on Feb. 7, 2024, which claims priority to and the benefit of Korean Patent Application No. 10-2023-0016623, filed Feb. 8, 2023, Korean Patent Application No. 10-2023-0159137, filed Nov. 16, 2023, and Korean Patent Application No. 10-2024-0017370, filed Feb. 5, 2024, the disclosures of which are incorporated herein by reference in its entirety.

### FIELD

The present disclosure relates to a plug connector and a receptacle connector for connecting electrical signals between circuit boards.

### BACKGROUND

Mobile electronic devices such as smartphones and tablets have the convenience of use without spatial constraints. Accordingly, as mobile electronic devices have become explosively popularized, they are being used innovatively in daily life and work, etc.

The convenience and innovation that mobile electronic devices have demand that more functions be installed in mobile electronic devices. Furthermore, such demands naturally increase the amounts of information that needs to be processed in mobile electronic devices.

However, despite the increase in information processing, it is necessary to maintain the convenience of portability. Accordingly, instead of suppressing the increase in size for portability, the circuits in mobile electronic devices are becoming increasingly densely integrated in their layout.

The information processed in mobile electronic devices is carried on electrical signals and transmitted via transmission lines. Accordingly, stability needs to be also considered such that electrical signals can be transmitted without signal distortion or loss due to noise in densely integrated circuits.

Meanwhile, connecting devices are used for electrical connection intended to transmit electrical signals between circuit boards in mobile electronic devices.

Such connecting devices are usually composed of a plug connector, which is a male connector, and a receptacle connector, which is a female connector.

The plug connector is coupled to a circuit board for the connection of a plug connector (hereinafter referred to as the ‘plug board’), and the receptacle connector is coupled to a circuit board for the connection of the receptacle connector (hereinafter referred to as the ‘receptacle board’). Furthermore, the plug connector and the receptacle connector are coupled to each other in a structure in which the plug connector is plugged into the receptacle connector. Accordingly, the transmission of electric signals between the circuits of the plug board and the receptacle board is performed via the connecting device.

In general, mobile electronic devices such as mobile phones are configured such that multiple circuit elements are arranged in a highly integrated structure in a narrow, limited space. Accordingly, signal interference between adjacent circuit elements and distortion may easily occur, which leads to signal loss. Such signal loss occurs not only when transmitting high-frequency signals but also when transmitting digital signals or camera image signals, which are relatively low-frequency signals. To prevent this, have been proposed technologies that provide a connecting device with shielders that can block noise.

The shielders need to be made of metallic material because they need to block noise in the form of electric waves. Furthermore, a body in which contact terminals are installed needs to be formed of synthetic resin, which is a non-metallic material, for the sake of insulation between the contact terminals.

It is obvious that even when shielders are applied, the increase in size needs to be minimized. At the same time, states of soldering to circuit boards need to be visually inspectable.

Meanwhile, when a plug connector is coupled to a receptacle connector, the couplings between a large number of contact terminals (the couplings between plug contacts and receptacle contacts) are required. Accordingly, it is necessary to apply a pressing force. When the pressing force is applied, (local) separation between the shielder and the body or deformation of a shielder frame (hereinafter referred to as ‘fastening deformation’) needs to be prevented.

### PRIOR ART LITERATURE

### Patent Literature

(Patent Document 1) Korean Patent Application No. 10-2020-0136577

(Patent Document 2) Korean Patent Application Publication No. 10-2020-0008840

### SUMMARY

The present disclosure has been conceived based on the following motives:

First, it is necessary to apply shielders to prevent the distortion of electric signals attributable to external noise in a connecting device.

Second, it is necessary to be able to perform the visual inspection of states of soldering with circuit boards while applying shielders.

Third, it is necessary to reduce the coupling force required to couple a plug connector and a receptacle connector to each other while achieving firm coupling between shielders and bodies.

According to the present disclosure, there is provided a plug connector including: a plug body formed of a non-conductive material; plug contacts fixedly installed to the plug body, and configured to come into contact with receptacle contacts of a receptacle connector; a pair of plug power contacts coupled to the plug body, and configured to come into contact with receptacle power contacts present in the receptacle connector; and a plug shielder configured to shield the plug contacts from external noise; wherein the plug body includes: a signal area portion in which the plug contacts are installed; and a pair of power area portions which are arranged to protrude further from both ends of the signal area portion, and in which the plug power contacts are installed; wherein the plug shielder has a structure that surrounds the periphery of the plug body while forming an arrangement space in which the plug contacts and the pair of plug power contacts are arranged therein; and wherein the plug shielder is coupled to the pair of power area portions.

According to a first aspect of the present disclosure, there is provided a receptacle connector including: a receptacle body formed of a non-conductive material; receptacle contacts fixedly installed to the receptacle body, and coupled with plug contacts of a plug connector; a pair of receptacle power contacts fixedly installed to the receptacle body, and configured to come into contact with plug power contacts present in the plug connector; and a receptacle shielder configured to shield the receptacle contacts from external noise; wherein the receptacle body includes: a signal area portion in which the receptacle contacts are installed; and a pair of power area parts which are arranged to protrude further from both ends of the signal area portion, and in which the receptacle power contacts are installed; wherein the receptacle shielder has a structure that surrounds a periphery of the receptacle body while forming an arrangement space in which the receptacle contacts and the pair of receptacle power contacts are arranged therein; and wherein the receptacle shielder is coupled to the pair of power area portions.

According to a second aspect of the present disclosure, there is provided a receptacle connector including: a receptacle body formed of a non-conductive material; receptacle contacts fixedly installed to the receptacle body, and coupled with plug contacts of a plug connector; a pair of receptacle power contacts coupled to the receptacle body, fixed to a receptacle board by soldering, and arranged on both front and rear sides of the receptacle body; and a receptacle shielder configured to shield the receptacle contacts from external noise, and having a structure that surrounds a periphery of the receptacle body while forming an arrangement space in which the receptacle contacts and the pair of receptacle power contacts are arranged therein; wherein the receptacle shielder includes: a first shielding portion which surrounds the periphery of the receptacle body and shields the receptacle contacts from external noise; and a second shielding portion which is formed by extending from the first shielding portion in an integrated form, is disposed inside the first shielding portion and blocks external noise along with the first shielding portion in a double manner.

According to the present disclosure, the following effects are achieved:

First, the shielders in the plug connector and the receptacle connector have a structure that covers not only the contacts (especially the mounting portions) but also the power contacts, so that shielding performance is improved and the structures of the shielders are simplified, which facilitates the design and fabrication of the shielders.

Second, the plug connector is equipped with the plug shielder for double blocking, so that the increase in the size of the connecting device can be minimized.

Third, the increase in the coupling force between the plug connector and the receptacle connector attributable to the shielders may be minimized, so that the coupling of the plug connector and the receptacle connector can be easily performed.

Fourth, the coupling between the shielders and the bodies is firm, so that there is no concern that defects occur during a process in which the plug connector and the receptacle connector are coupled to each other.

In addition, other various effects attributable to the individual components will be additionally described in the relevant parts.

### BRIEF DESCRIPTION OF THE DRAWINGS

FIG. 1 is an assembled view of a connecting device according to one embodiment of the present disclosure;

FIG. 2 is a partially exploded view of the connecting device of FIG. 1;

FIGS. 3 to 5 are reference diagrams illustrating plug contacts and receptacle contacts applied to the connecting device of FIG. 1;

FIGS. 6 to 14 are reference diagrams illustrating a plug connector applied to the connecting device of FIG. 1;

FIGS. 15 to 22 are reference diagrams illustrating a receptacle connector applied to the connecting device of FIG. 1; and

FIGS. 23 to 30 are reference diagrams illustrating the features of the connecting device of FIG. 1.

FIGS. 31 to 33 are respectively an exploded view, a plan view and a bottom view of a receptacle connector according to a modified embodiment of the present invention; and

FIG. 34 shows a plug connector according to the modified embodiment of the present invention.

### DETAILED DESCRIPTION

Preferred embodiments according to the present disclosure will be described with reference to the accompanying drawings. For the sake of brevity, descriptions of well-known configurations will be omitted or abridged as much as possible.

### Overview of Connecting Device

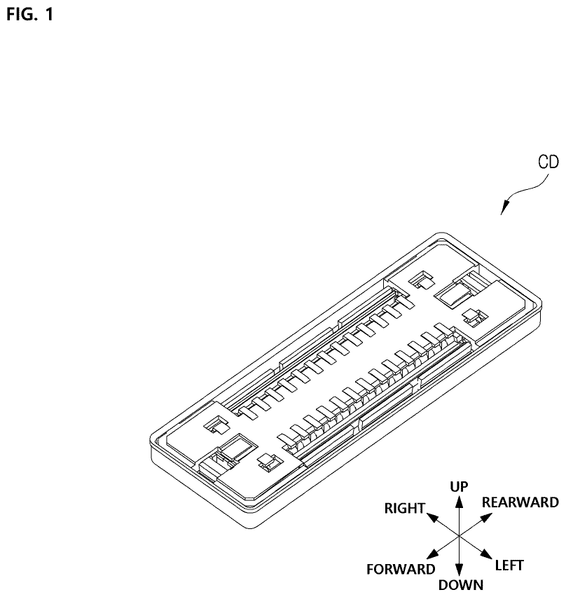

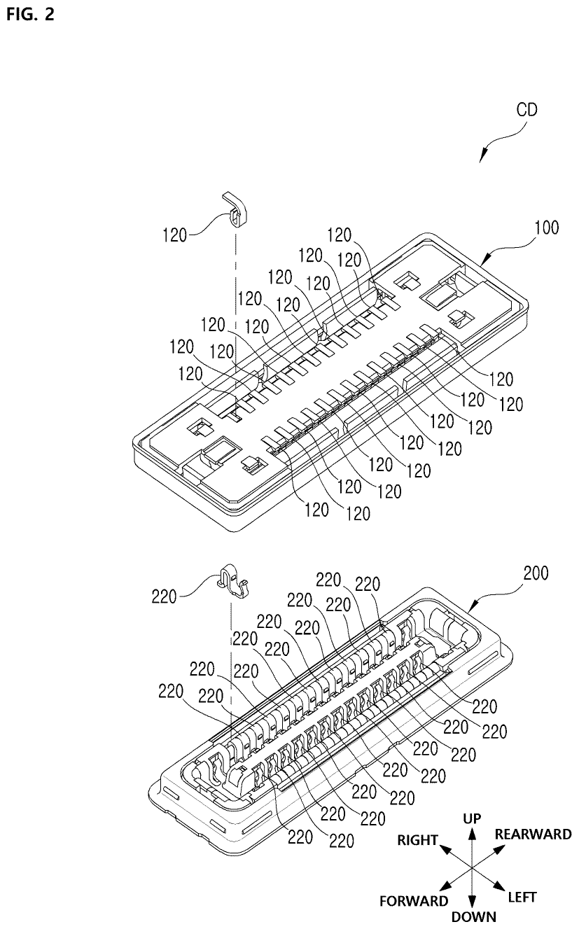

FIG. 1 is an assembled view of a connecting device CD according to one embodiment of the present disclosure, and FIG. 2 is a partially exploded view of the connecting device CD of FIG. 1.

The connecting device CD includes a plug connector 100 and a receptacle connector 200.

In the example of FIGS. 1 and 2, the plug connector 100 is disposed on the upper side, and the receptacle connector 200 is disposed on the lower side. However, the directions in which the plug connector 100 and the receptacle connector 200 are disposed may vary depending on the installation location, and thus, should not be interpreted as being limited to the directions presented in FIGS. 1 and 2.

The plug connector 100 and the receptacle connector 200 are coupled to each other in a structure in which the plug contacts 120 of the plug connector 100 are inserted and fitted into the receptacle contacts 220 of the receptacle connector 200.

The plug contacts 120 and the receptacle contacts 220 are fabricated of a conductive material so that electrical signals can be conducted therethrough.

According to one example of the present disclosure, a plurality of plug contacts 120 are arranged in two left and right rows in the plug connector 100, and a plurality of receptacle contacts 220 are arranged in two left and right rows in the receptacle connector 200. However, the present disclosure is not limited to the numbers of plug contacts 120 and receptacle contacts 220 or the numbers of rows.

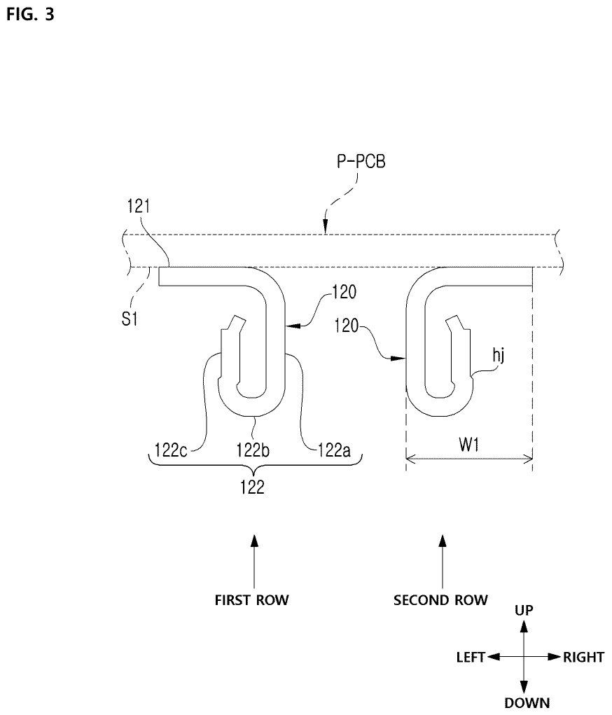

As shown in FIG. 3, the plug contacts 120 of a first row and the plug contacts 120 of a second row have the same symmetrical shapes and structures.

The plug contacts 120 each have a plug contact mounting portion 121 and a plug contact contact portion 122.

The plug contact mounting portion 121 is mounted on a plug board P-PCB by soldering. To this end, the plug contact mounting portion 121 has a shape that extends in a direction (the left-right direction in the drawing) approximately parallel to the surface S1 of the plug board P-PCB.

The plug contact contact portion 122 is inserted and fitted into one of the receptacle contacts 220 of the receptacle connector 200. Accordingly, the plug contact 120 and the receptacle contact 220 are connected to come into electrical contact with each other. Furthermore, the plug connector 100 and the receptacle connector 200 are also coupled to each other.

The plug contact contact portion 122 may be divided into a support member 122a, a connection member 122b, and a contact member 122c.

The support member 122a is bent approximately vertically and downward from the plug contact mounting portion 121 and then extended.

The connection member 122b connects the support member 122a and the contact member 122c.

The contact member 122c faces the support member 122a, and is bent approximately upward from the connecting member 122b and then extended.

Since the contact member 122c is bent slightly from the connection member 122b and then extended, the plug contact contact portion 122 has a stop protrusion hj.

The support member 122a and the contact member 122c are connected to each other by the connection member 122b to be spaced apart from each other.

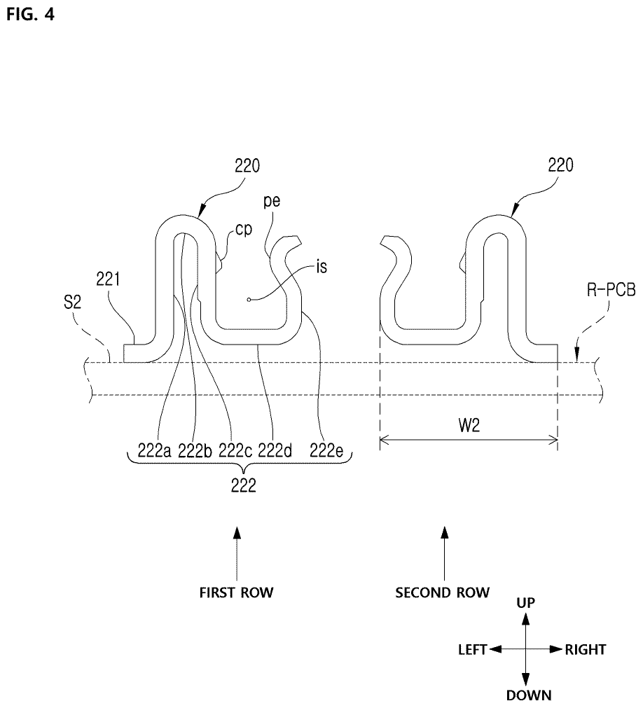

Next, referring to FIG. 4, the receptacle contacts 220 in the receptacle connector 200 will be discussed.

The receptacle contacts 220 of a first row and the receptacle contacts 220 of a second row have the same symmetrical shapes and structures.

The receptacle contacts 220 each have a receptacle contact mounting portion 221 and a receptacle contact contact portion 222.

The receptacle contact mounting portion 221 is soldered to a receptacle board R-PCB. To this end, the receptacle contact mounting portion 221 has a shape that extends in a direction (the left-right direction in the drawing) approximately parallel to the surface S2 of the receptacle board R-PCB.

The receptacle contact contact portion 222 is fitted and coupled into the plug contact contact portion 122 described above. To this end, the receptacle contact contact portion 222 may be divided into a support member 222a, a connection member 222b, a contact member 222c, an extension member 222d, and a compression member 222e.

The support member 222a is bent approximately vertically and upward from the receptacle contact mounting portion 221 and then extended.

The connection member 222b connects the support member 222a and the contact member 222c.

The contact member 222c, the extension member 222d, and the compression member 222e have a structure that forms an insertion space open upward while constituting an approximately ‘U’ shape.

The contact member 222c faces the support member 222a, and is bent approximately downward from the connection member 222b and then extended. A contact protrusion cp protruding toward the insertion space is formed on the contact member 222c.

The extension member 222d is formed to extend from an end (the bottom end in FIG. 4) of the contact member 222c toward the opposite side of the support member 222a in a direction (the left-right direction in the drawing) approximately parallel to the surface S2 of the receptacle board R-PCB.

The compression member 222e is bent approximately upward from an end (the right end in the first row of FIG. 4) of the extension member 222d and then extended.

The compression member 222e is formed to be curved in order to have a protruding end pe protruding toward the insertion space is. Furthermore, an end (the top end in FIG. 4) of the compression member 222e is a free end, and thus, may be deformed elastically.

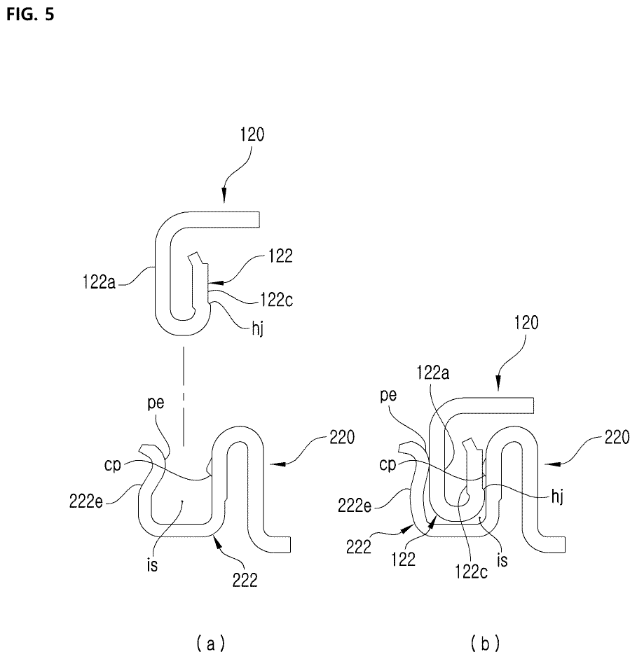

Meanwhile, for the fitting coupling between the plug contact 120 and the receptacle contact 220, reference may be made to FIGS. 5(a) and 5(b).

As shown in FIG. 5, the plug contact contact portion 122 of the plug contact 120 is fitted and inserted into the insertion space is that is formed by the receptacle contact 220, so that the plug contact 120 and the receptacle contact 220 come into contact with each other. In the insertion process from FIG. 5(a) to FIG. 5(b), as the receptacle contact contact portion 222 having the compression member 222e is elastically deformed, the plug contact contact portion 122 is appropriately inserted into the insertion space is.

When the plug contact contact portion 122 is completely inserted into the insertion space is, the elastic restoring force of the receptacle contact contact portion 222 is applied such that the contact protrusion cp of the receptacle contact 220 comes into close contact with the contact member 122c of the plug contact 120. Furthermore, the protruding end pe of the receptacle contact 220 comes into close contact with the support member 122a of the plug contact 120. Accordingly, the plug contact contact portion 122 of the plug contact 120 and the receptacle contact contact portion 222 of the receptacle contact 220 come into contact with each other at two contact points. Furthermore, the elastic restoring force of the receptacle contact contact portion 222 and the engagement structure of the stop protrusion hj and the contact protrusion cp maintain the contact force between the plug contact 120 and the receptacle contact 220, thereby enhancing a contact state.

For reference, in the example of FIGS. 3 to 5, the receptacle contact 220 needs to form the insertion space is, so that the width W2 of the receptacle contact 220 needs to be wider than the width W1 of the plug contact 120. Furthermore, this point is related to the coupling structure of a plug shielder and a receptacle shielder to be described later, and this will be described later.

Next, the plug connector 100 and the receptacle connector 200 will be described in more detail under separate section titles.

### Description of Plug Connector

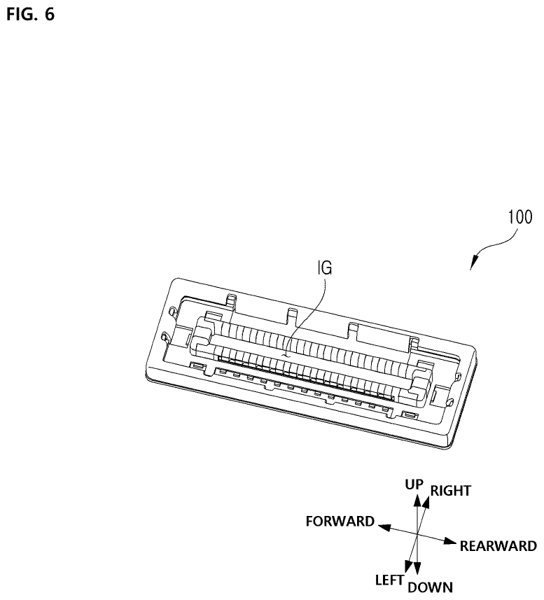

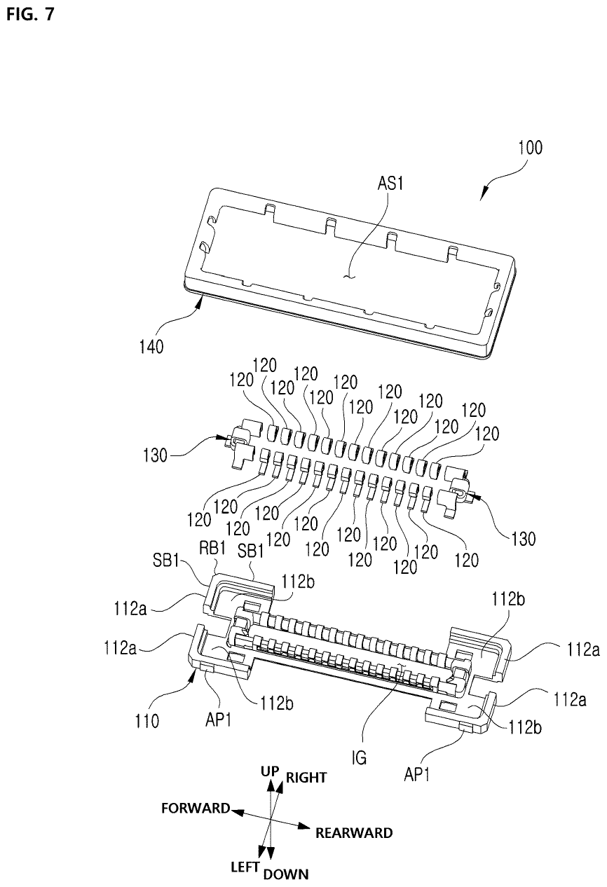

As shown in the perspective view of FIG. 6 and the exploded view of FIG. 7, the plug connector 100 includes a plug body 110, plug contacts 120, a pair of plug power contacts 130, and a plug shielder 140.

For reference, in the individual description of the plug connector 100 made with reference to FIGS. 6 and 7, the direction is defined such that the plug board P-PCB is located below the plug connector 100.

The plug body 110 is provided as a body that supports the plug contacts 120 and the plug power contacts 130. In other words, the plug contacts 120 and the plug power contacts 130 are installed in the plug body 110.

The plug body 110 is fabricated of a non-conductive material such as synthetic resin for the sake of insulation between the plug contacts 120 and the plug power contacts 130, and has an insertion groove IG elongated in the front-rear direction.

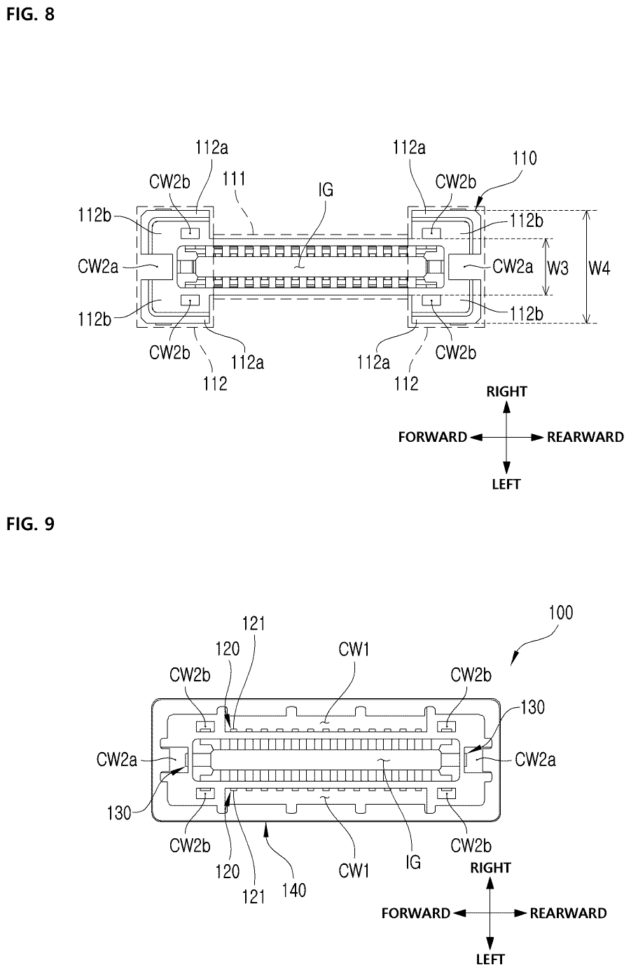

As shown in the plan view of FIG. 8, the plug body 110 may be divided into a signal area portion 111 and a pair of front and rear power area portions 112.

The width W3 of the signal area portion 111 in the left-right direction is narrower than the width W4 of the power area portions 112 in the left-right direction. Accordingly, as shown in FIG. 9, which illustrates the plane of the plug connector 100, the plug connector 100 has first checking windows CW1 formed between the plug contacts 120 and the plug shielder 140. The first checking windows CW1 are formed at a position that roughly corresponds to the signal area portion 111.

In the signal area portion 111, the plug contacts 120 are installed in two rows with the insertion groove IG interposed therebetween. Furthermore, as shown in FIG. 9, the plug contact mounting portions 121 of the plug contacts 120 protrude somewhat into the area of the first checking windows CW1. Accordingly, an inspector may visually check whether the soldering coupling between the plug contact mounting portions 121 and the plug board P-PCB has been appropriately performed through the first checking windows CW1.

The pair of power area portions 112 are arranged at the front and rear ends of the signal area portion 111. It is obvious that the power area portions 112 together with the signal area portion 111 may be injection-molded into an integrated form. Accordingly, the injection-molding is performed in a structure in which the power area portions 112 protrude further in the front and rear directions from the front and rear ends of the signal area portion 111.

The plug power contacts 130 are installed in the power area portions 112, respectively.

Furthermore, in the power area portions 112, second checking windows CW2a and CW2b are formed at the points where each of the plug power contacts 130 is soldered to the plug board P-PCB. Accordingly, an inspector may visually check whether the soldering coupling between the plug power contacts 130 and the plug board P-PCB has been appropriately formed through the second checking windows CW2a and CW2b.

According to the present embodiment, the second checking windows CW2a and CW2b are formed in the plug body 110. Accordingly, the second checking windows CW2a and CW2b are partitioned from the first checking windows CW1 by the plug body 110. Therefore, an inspector's confusion between the soldering state of the plug contacts 120 and the soldering state of the plug power contacts 130 is prevented. However, the second checking windows CW2a and CW2b may be implemented such that not all of them are partitioned from the first checking windows CW1, but only some of them are partitioned from the first checking windows CW1.

Referring to FIGS. 7 and 8 again, coupling portions 112a to which the plug shielder 140 to be described later is coupled are formed to protrude upward along the edge areas of the power area portions 112. Accordingly, the plug body 110 may be coupled to the plug shielder 140 by the coupling portions 112a of the power area portions 112.

The coupling portions 112a are each formed to extend to protrude upward from one of the bottom surfaces 112b that extend out of the plug power contacts 130.

The coupling portions 112a are each provided with two straight sections SB1 and a curved section RB1.

The two straight sections SB1 are adjacent to each other and arranged at an angle of 90 degrees.

The curved section RB1 is disposed between the two straight sections SB1.

The curved section RB1 connects the two straight sections SB1 in a curved structure so that the two straight sections SB1 can be arranged at an angle of 90 degrees to each other. It is obvious that the two straight sections SB1 and the curved section RB1 are formed in an integrated form.

The coupling portions 112a will be further described later.

The plug contacts 120 have the structure of FIG. 3 described above. In the present embodiment, a total of 26 plug contacts 120 are provided, and are arranged in two left and right rows of 13 each in parallel in the front-rear direction with the insertion groove IG interposed therebetween.

A total of two plug power contacts 130 are provided and coupled to the plug body 110.

The plug power contacts 130 are installed in the power area portions 112 on both the front and rear sides of the plug body 110 in symmetrical shapes and structures.

The plug power contacts 130 are provided to transmit power. For this purpose, the plug power contacts 130 are formed of a metal material that can conduct electricity.

In addition, the plug power contacts 130 are firmly fastened to the plug board P-PCB, and thus, ultimately has a hold-down function for firmly fastening the plug connector 100 to the plug board P-PCB. Accordingly, the plug power contacts 130 are each soldered to the plug board P-PCB at multiple points (three points in the present embodiment). Furthermore, the soldering states between the plug power contacts 130 and the plug board P-PCB may be checked by an inspector through the second checking windows CW2a and CW2b.

In addition, the plug power contacts 130 are formed of a metal material that is stronger than synthetic resin, so that they also have a reinforcing function that reinforces the strength of the power area portions 112.

It is obvious that the power transmission function, hold-down function, and reinforcement function of the plug power contact 130 may be divided according to its respective function and provided for separate components. However, by mounting the three functions on the plug power contact 130, space saving and design simplification may be achieved.

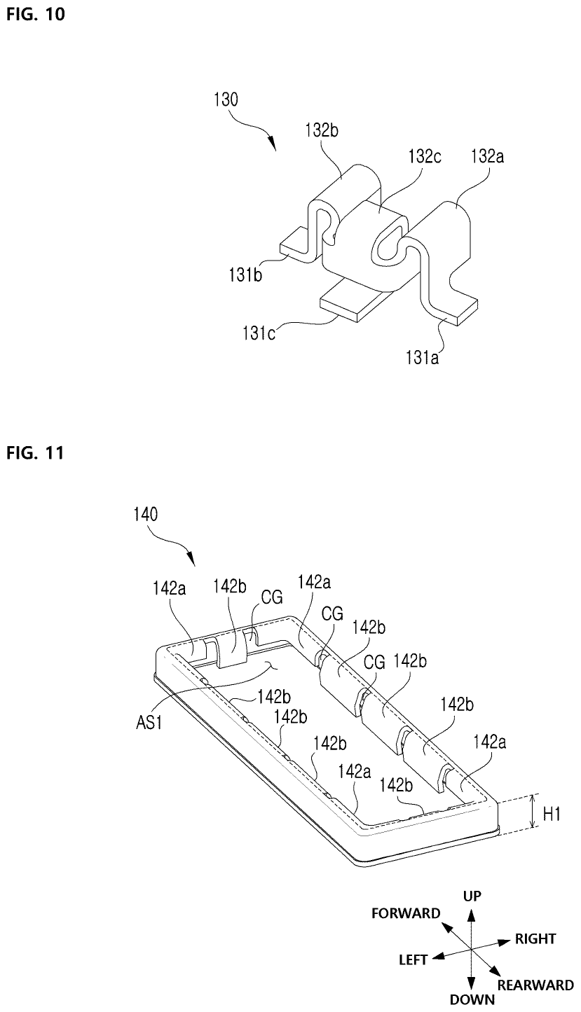

As shown in FIG. 10, the plug power contacts 130 each include three mounting members 131a, 131b and 131c and three contact members 132a, 132b and 132c.

The three mounting members 131a, 131b and 131c are each mounted on the plug board P-PCB by soldering. As described above, the appropriateness of the soldering coupling performed at three points between the mounting members 131a, 131b and 131c and the plug board P-PCB may be visually checked through the three second checking windows CW2a and CW2b.

The three contact members 132a, 132b and 132c are each electrically connected and mechanically coupled to the receptacle power contacts 230.

Meanwhile, the plug body 110 is injected in the state in which the plug contacts 120 and the plug power contacts 130 have been inserted into the mold. Accordingly, the plug body 110, the plug contacts 120, and the plug power contacts 130 are firmly integrated with each other to constitute a single module.

Referring to the excerpt views of FIGS. 7 and 11, the plug shielder 140 forms an arrangement space AS1 in which the plug contacts 120 and the plug power contacts 130 are arranged therein. To this end, the plug shielder 140 in the present embodiment has a structure that surrounds the side peripheries of the corner areas of the plug body 110 in which the plug contacts 120 are installed.

The fact that the plug contacts 120 are arranged in the arrangement space AS1 means that the plug contact mounting portions 121 of the plug contacts 120 are also located in the arrangement space AS1. Accordingly, the plug contact mounting portions 121 of the plug contacts 120 are not located on the same vertical line as the plug shielder 140, or do not protrude out of the plug shielder 140 to the outside of the plug shielder 140. In this case, the vertical line may be interpreted as a straight line in the direction in which the plug connectors 100 and the receptacle connectors 200 that are mutually fitted and coupled into each other are coupled to each other.

The plug shielder 140 is coupled to the plug body 110 by being coupled to the pair of power area portions 112 present in the plug body 110. In contrast, the plug body 110 and the plug shielder 140 are not coupled to each other in the signal area portion 111.

According to the present embodiment, the plug shielder 140 has two functions.

The first function of the plug shielder 140 is to reinforce the strength of the plug body 110.

The second function of the plug shielder 140 is to shield the plug contacts 120 from external noise and to prevent the signals of the plug contacts 120 from leaking to the outside. The present disclosure is particularly related to the second function of the plug shielder 140.

According to the present disclosure, the plug shielder 140 needs to be fabricated of a shielding material capable of blocking noise. Since the plug shielder 140 is connected to the grounding terminal of the plug board P-PCB, it functions as a grounding element. Accordingly, to perform this function, the plug shielder 140 needs to be formed of a conductive metal material.

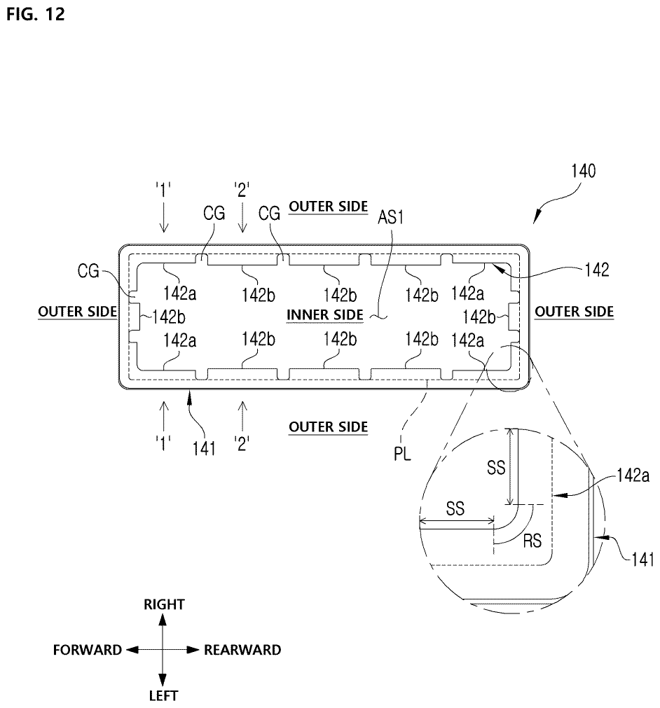

The plug shielder 140 is preferably fabricated in a roughly square frame shape to surround the side peripheries of the plug body 110. Furthermore, as indicated by the arbitrary dotted line PL in the plan view of FIG. 12, the plug shielder 140 may be divided into an outer side first shielding portion 141 and an inner side second shielding portion 142. In this case, the inner side refers to the area where the arrangement space AS1 where the plug contacts 120 are arranged is located based on the dotted line PL. Furthermore, the outer side refers to the outer side of the plug connector 100 as the opposite side of the inner side.

As seen from FIG. 11, the first shielding portion 141 is formed to have a height H1 in a direction (the up-down direction in the drawing) approximately perpendicular to the surface S1 of the plug board P-PCB, and is provided in a simple structure having a square frame shape that is connected in an integrated form without a joint.

The first shielding portion 141 surrounds the side peripheries of the plug body 110. Furthermore, the lower end of the first shielding portion 141 comes into contact with the plug board P-PCB.

The second shielding portion 142 is fabricated together with the first shielding portion 141 in an integrated form, and is formed to extend inward from the first shielding portion 141. That is, the first shielding portion 141 is disposed relatively on the outer side, and the second shielding portion 142 is disposed relatively on the inner side.

The second shielding portion 142 is formed in a structure that is bent downward from the top of the first shielding portion 141 and then extended in an integrated form.

The second shielding portion 142 has a discontinuous structure that is cut at multiple points, unlike the first shielding portion 141. Accordingly, the second shielding portion 142 has fixed members 142a and movable members 142b that are spaced apart from each other.

The fixed members 142a have the same mechanical structure only at different arrangement positions. Furthermore, the movable members 142b also have the same mechanical structure only at different arrangement positions. Accordingly, a description of some of them will be substituted for descriptions of the rest.

The fixed members 142a are formed by extending from the four corner areas of the first shielding portion 141. Accordingly, referring to the enlarged area of FIG. 12, the fixed members 142a each have two straight sections SS and a curved section RS.

The two straight sections SS are adjacent to each other, and are arranged at an angle of 90 degrees.

The curved section RS is disposed between the two straight sections SS.

The curved section RS connects the two straight sections SS in a curved structure so that the two straight sections SS can be arranged at an angle of 90 degrees to each other. It is obvious that the two straight sections SS and the curved section RS are connected to one another in an integrated form without a joint, so that noise can be completely blocked in the corner areas.

The above fixed members 142a correspond to the coupling portions 112a of the plug body 110.

The two straight sections SS of the fixed member 142a correspond to the two straight sections SB1 of the coupling portion 112a. Furthermore, the curved section RS of the fixed member 142a corresponds to the curved section RB1 of the coupling portion 112a. Accordingly, the straight sections SS of the plug shielder 140 are coupled to the straight sections SB1 of the plug body 110, and the curved sections RS of the plug shielder 140 are coupled to the curved sections RB1 of the plug body 110.

According to the present embodiment, the coupling force between the plug body 110 and the plug shielder 140 is increased through the straight sections SB1 and SS at both ends of the curved sections RB1 and RS of the plug body 110 and the plug shielder 140. Furthermore, the straight sections SB1 and SS firmly hold the curved sections RB1 and RS at both ends of the curved sections RB1 and RS. Accordingly, the straight sections SB1 and SS have the function of preventing the bending or deformation of the curved sections RB1 and RS. Accordingly, the straight sections SB1 and SS contribute to guiding the plug connector 100 and the receptacle connector 200 through the coupling therebetween and stably maintaining the coupling. In other words, the straight sections SB1 and RB pursue the provision of structural stability that may not be sufficiently provided by the curved sections RB1 and RS alone.

The movable members 142b are arranged between the individual corner areas. In other words, the movable members 142b are arranged between the individual fixed members 142a.

The movable members 142b and the fixed members 142a are separated by cutouts CG.

It is obvious that the movable members 142b are also formed by extending from the first shielding portion 141 in an integrated form.

According to a preferred example of the present disclosure, the fixed members 142a are arranged in areas corresponding to the coupling portions 112a of the plug body 110. Furthermore, the movable members 142b are arranged between the fixed members 142a.

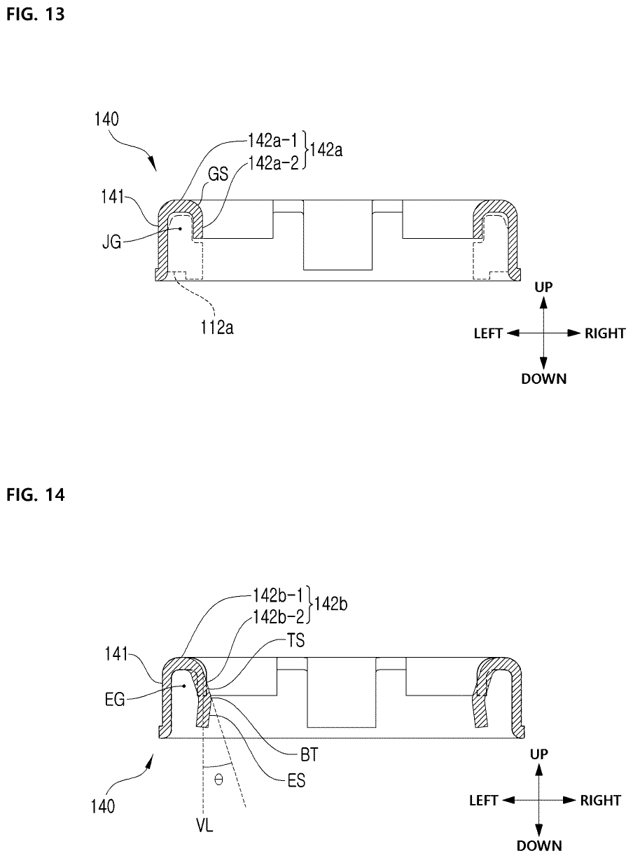

The structures and functions of the fixed members 142a and the movable members 142b will be described in more detail with reference to FIGS. 13 and 14.

FIG. 13 is a sectional view of an area where the fixed members 142a are located, which is taken along line 1-1 of FIG. 12, and FIG. 14 is a sectional view of an area where the movable members 142b are located, which is taken along line 2-2 of FIG. 12. Furthermore, each of the sectional views is depicted from a viewpoint from the rear toward the front.

First, referring to FIG. 13, the section of an area where the fixed members 142a are present can be viewed.

Each of the fixed members 142a includes an integrated connection portion 142a-1 and a spaced extension portion 142a-2.

The integrated connection portion 142a-1 is bent inward from the top end of the first shielding portion 141 and then extended, and connects the spaced extension portion 142a-2 to the first shielding portion 141 in an integrated form.

The spaced extension portion 142a-2 is located inside the first shielding portion 141 and spaced apart from the first shielding portion 141, and is formed to be approximately perpendicular to the surface S1 of the plug board P-PCB. Accordingly, the spaced extension portion 142a-2 extends vertically downward from the inner end of the integrated connection portion 142a-1. However, the vertical length of the integrated connection portion 142a-2 is shorter than the vertical length of the first shielding portion 141.

The structure of the integrated connection portion 142a-1 and the spaced extension portion 142a-2 forms a coupling depression JG between the first shielding portion 141 and the spaced extension portion 142a-2. The coupling portion 112a of the plug body 110 is inserted into the coupling depression JG in a fitting manner (see the dotted line in FIG. 13). Accordingly, the plug shielder 140 may be fixedly coupled to the plug body 110. That is, the plug body 110 and the plug shielder 140 are fixedly coupled to each other by the coupling portions 112a present in the power area portions 112 of the plug body 110 and the coupling depressions JG formed by the plug shielder 140.

In addition, the section where the integrated connection portion 142a-1 and the spaced extension portion 142a-2 are connected is formed to be somewhat rounded, so that it functions as an insertion guide section GS.

The insertion guide sections GS correct the coupling position of the plug connector 100 and the receptacle connector 200 during a process in which the plug connector 100 and the receptacle connector 200 are coupled to each other. Accordingly, the insertion guide sections GS guide the plug connector 100 and the receptacle connector 200 through their appropriate coupling. This point will be described in more detail later after the description of the receptacle connector 200.

Referring to FIG. 14, the sections of the movable members 142b can be viewed.

Each of the movable members 142b may be divided into an elastic connection portion 142b-1 and a shielder contact portion 142b-2.

The elastic connection portion 142b-1 is bent inward from the top end of the first shielding portion 141 and then extended, and connects the shielder connection portion 142b-2 to the first shielding portion 141 in an integrated form. Since the elastic connection portion 142b-1 has elastic bending and restoring force, it enables the swinging motion of the movable member 142b.

The shielder contact portion 142b-2 is located on the inner side of the first shielding part 141, and is bent approximately downward from the inner end of the elastic connection portion 142b-1 and then extended.

The shielder contact portion 142b-2 comes into contact with the receptacle shielder of the receptacle connector 200 to be described later. To this end, the shielder contact portion 142b-2 has an inclined surface TS that extends to be inwardly inclined within a range of angles Θ greater than 0 degrees and less than 90 degrees with respect to a vertical line VL from the elastic connection portion 142b-1.

According to a preferred example, the inclined surface TS may be formed only in a part of the shielder contact portion 142b-2.

According to the present embodiment, the shielder contact portion 142b-2 further has an extended surface ES that additionally extends downward from the inclined surface TS.

The extended surface ES is slightly bent outward from the inclined surface TS and then extended. Accordingly, a boundary area BT between the inclined surface TS and the extended surface ES has a shape that protrudes inward. This boundary area BT functions as a contact line through which the plug shielder 140 comes into contact with the receptacle shielder to be described later.

The structure of the elastic connection portion 142b-1 and the shielder contact portion 142b-2 forms an elastic depression EG between the first shielding portion 141 and the shielder contact portion 142b-2.

The elastic depression EG is formed as an empty space where the plug body 110 is not present. Accordingly, the swing movement of the movable member 142b is allowed when the movable member 142b swings due to elastic deformation.

Meanwhile, the movable members 142b are formed by cutting the second shielding portion 142. When the second shielding portion 142 is cut at multiple points in the area between the fixed portions 142a, multiple movable members 142b may be formed per side of the second shielding portion 142. When the number of movable members 142b is increased in this manner, the resistance due to the movable members 142b is reduced when the plug connector 100 is coupled to the receptacle connector 200, so that the fitting force required for coupling can be reduced. That is, according to the present embodiment, it may be desirably contemplated that fabrication is made such that the number of movable members 142b is larger than the number of fixed members 142a. However, in order to maximize the shielding power and maintain the strength of the structure, it is necessary to form an appropriate number of movable members 142b. Accordingly, in the present embodiment, a plurality of movable members 142b are formed on the long side of the plug shielder 140, but only one movable member 142b is formed on the short side thereof.

### Description of Receptacle Connector

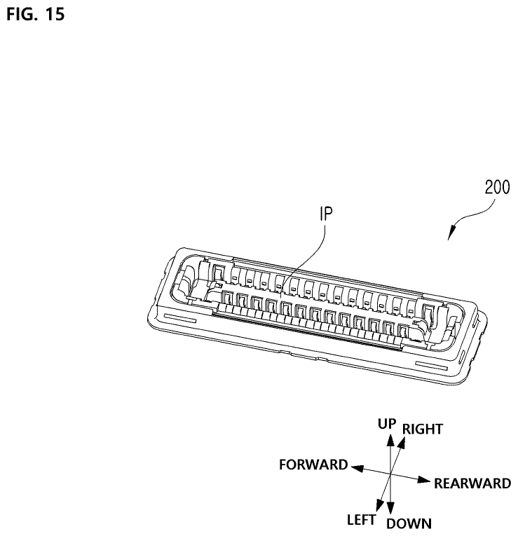

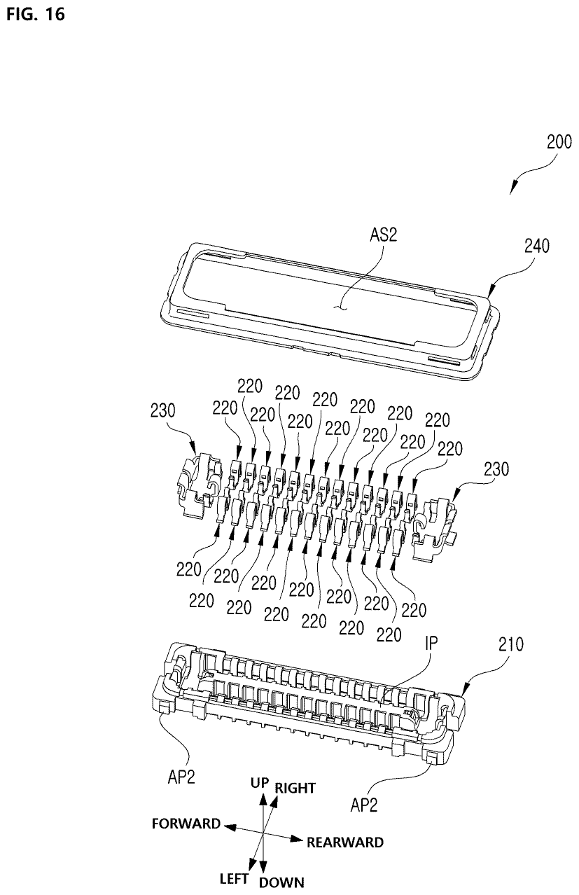

As shown in the perspective view of FIG. 15 and the exploded view of FIG. 16, the receptacle connector 200 includes a receptacle body 210, receptacle contacts 220, a pair of receptacle power contacts 230, and a receptacle shielder (a socket shielder) 240.

The receptacle body 210 supports the receptacle contacts 220 and the receptacle power contacts 230. In other words, the receptacle contacts 220 and the receptacle power contacts 230 are installed in the receptacle body 210.

The receptacle body 210 is made of a non-conductive material such as synthetic resin, and has a long insertion protrusion IP in the left-right direction. When the plug connector 100 and the receptacle connector 200 are coupled to each other, the insertion protrusion IP is inserted into the insertion groove IG present in the plug body 110.

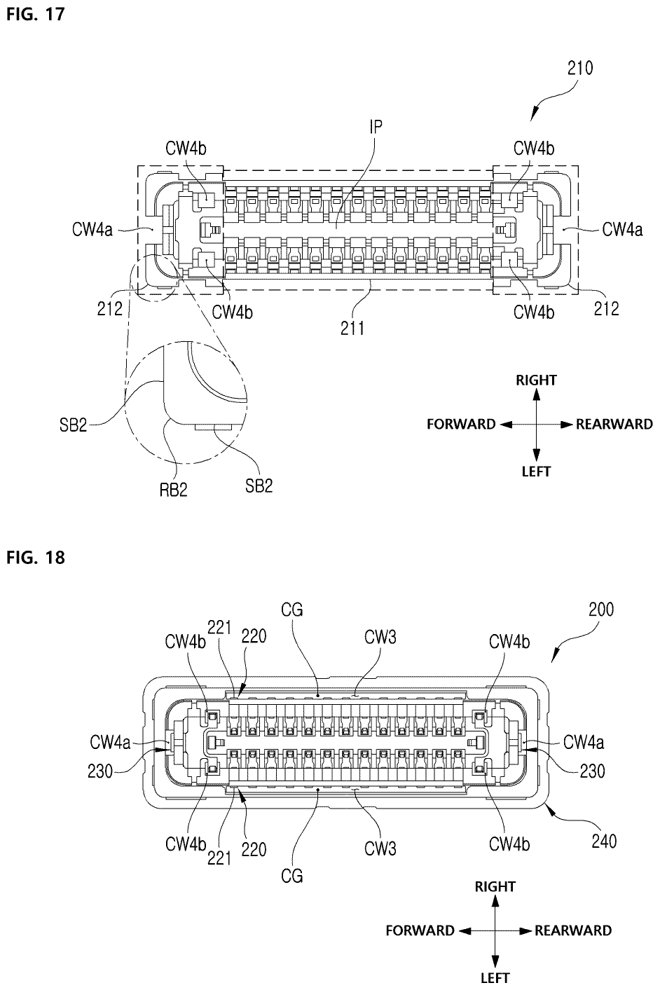

As shown in the plan view of FIG. 17, the receptacle body 210 may be divided into a signal area portion 211 and a pair of power area portions 212.

In the signal area portion 211, the receptacle contacts 220 are installed in two front and rear rows with the insertion protrusion IP interposed therebetween.

Referring to FIG. 18, which is a plan view of the receptacle connector 200, the receptacle connector 200 has a third checking window CW3 formed between the receptacle contacts 220 and the receptacle shielder 240.

The receptacle contact mounting portions 221 of the receptacle contacts 220 protrude somewhat into the area of the third checking window CW3. Accordingly, an inspector may visually check whether the soldering coupling between the receptacle contact mounting portions 221 of the receptacle contacts 220 and the receptacle board R-PCB has been appropriately performed through the third checking window CW3.

The pair of power area portions 212 are arranged at the front and rear ends of the signal area portion 211. Similarly, the power area portions 212 are formed together with the signal area portion 211 in an integrated form. Accordingly, the power area portions 212 are injection-molded in a structure that protrudes further in the front and rear directions from the front and rear ends of the signal area portion 211.

The receptacle power contacts 230 are installed in the power area portions 212, respectively.

In addition, in the power area portions 212, fourth checking windows CW4a and CW4b are formed at the points where the receptacle power contacts 230 are soldered to the receptacle board R-PCB. Accordingly, an inspector may visually check whether the soldering coupling between the receptacle power contacts 230 and the receptacle board R-PCB has been appropriately performed through the fourth checking windows CW4a and CW4b.

The fourth checking windows CW4a and CW4b are formed in the receptacle body 210. Accordingly, the fourth checking windows CW4a and CW4b are partitioned from the third checking window CW3. In this case, the fourth checking windows CW4a and CW4b may not be partitioned from the third checking window CW3, but only some of them may be partitioned from the third checking window CW3. For example, only the fourth checking window having the symbol CW4a may be designed to have a structure in which it is partitioned from the third checking window CW3.

In the same manner, the receptacle body 210 is coupled to the receptacle shielder 240 by the power area portions 212.

Referring to the enlarged portion of FIG. 17, the edge area of the power area portion 212 has two straight sections SB2 and a curved section RB2.

The two straight sections SB2 are adjacent to each other and arranged at an angle of 90 degrees.

The curved section RB2 is disposed between the two straight sections SB2.

The curved section RB2 connects the two straight sections SB2 in a curved structure so that the two straight sections SB2 can be arranged at an angle of 90 degrees to each other. It is obvious that the two straight sections SB2 and the curved section RS2 are formed in an integrated form.

Referring to the enlarged portion of FIG. 17, even in the receptacle connector 200, the receptacle shielder 240 has a structure in which it is coupled to the receptacle body 210 in the straight sections SB2 and curved section RB2 of the receptacle body 210. Accordingly, the coupling force between the receptacle body 210 and the receptacle shielder 240 is increased, the plug connector 100 and the receptacle connector 200 are guided through the coupling therebetween, and the coupling is stably maintained.

The receptacle contacts 220 have the structure of FIG. 4 described above. In the present embodiment, a total of 26 receptacle contacts 220 are provided to correspond to the plug contacts 120, and are divided into two rows of 13 each in the left-right direction and arranged in parallel in the front-rear direction with the insertion protrusion IP interposed therebetween.

Each of the receptacle contacts 220 may be electrically connected and mechanically coupled to each of the plug contacts 120.

A total of two receptacle power contacts 230 are provided, and are installed in the two power area portions 212, respectively.

The receptacle power contacts 230 correspond to the plug power contacts 130, and are provided to transmit power. Similarly, the receptacle power contacts 230 are formed of a metal material that can conduct electricity.

In addition, the receptacle power contacts 230 have a hold-down function for firmly fastening the receptacle connector 200 to the receptacle board R-PCB. Accordingly, the receptacle power contacts 230 are each soldered to the receptacle board R-PCB at three points.

In addition, since the receptacle power contacts 230 are formed of a metal material that is stronger than synthetic resin, they also have a reinforcing function that reinforces the strength of the power area portions 212.

It is obvious that the power transmission function, hold-down function, and reinforcement function of the receptacle power contact 230 may be divided according to their function and provided for separate components. However, by mounting the three functions on one receptacle power contact 230, space saving and design simplification may be achieved.

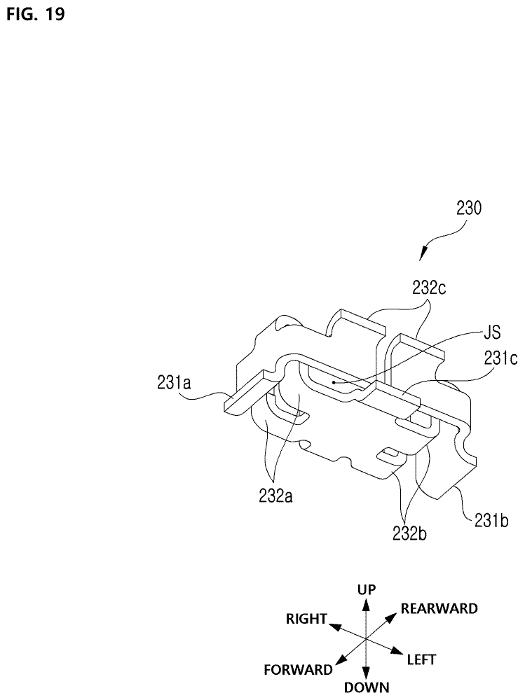

As in FIG. 19, the receptacle power contacts 230 each also include mounting members 231a, 231b and 231c and contact members 232a, 232b and 232c.

The mounting members 231a, 231b and 231c are each mounted on the receptacle board R-PCB.

The contact members 232a, 232b and 232c come into electric contact with the contact members 132a, 132b and 132c present in the plug power contact 130, respectively.

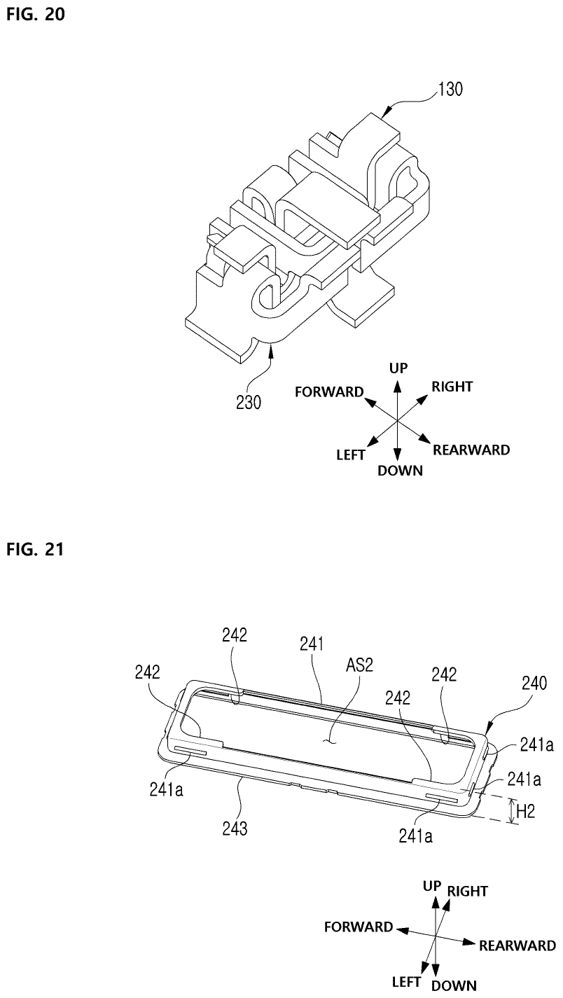

According to the present embodiment, the receptacle power contact 230 forms coupling spaces JS by the mechanical shapes of the contact members 232a, 232b and 232c. Furthermore, as shown in FIG. 20, the three contact members 132a, 132b and 132c present in the plug power contact 130 are fitted and inserted into the coupling spaces JS, so that the plug power contact 130 and the receptacle power contact 230 come into electric contact with and are mechanically coupled to each other.

Meanwhile, the receptacle body 210 is also injected in the state in which the receptacle contacts 220 and the receptacle power contacts 230 have been inserted into the mold. Accordingly, the receptacle body 210, the receptacle contacts 220, and the receptacle power contacts 230 are mutually rigidly integrated into a single module. Referring to FIG. 16 and FIG. 21, which is an excerpt view, the receptacle shielder 240 forms an arrangement space AS2 in which the receptacle contacts 220 and the receptacle power contacts 230 are arranged therein. To this end, the receptacle shielder 240 in the present embodiment has a structure that surrounds the side peripheries of the receptacle body 210 in which the receptacle contacts 220 are installed.

The fact that the receptacle contacts 220 are arranged in the arrangement space AS2 means that the receptacle contact mounting portions 221 of the receptacle contacts 220 are also located in the arrangement space AS2. Accordingly, the receptacle contact mounting portions 221 of the receptacle contacts 220 are located on the same vertical line as the receptacle shielder 240, or do not protrude out of the receptacle shielder 240 to the outside of the receptacle shielder 240.

The receptacle shielder 240 is coupled to the receptacle body 210 by being coupled to the pair of power area portions 212 in the receptacle body 210. In contrast, the receptacle body 210 and the receptacle shielder 240 are not coupled to each other in the signal area portion 211.

According to the present embodiment, the receptacle shielder 240 has two functions.

The first function of the receptacle shielder 240 is to reinforce the strength of the receptacle body 210.

The second function of the receptacle shielder 240 is to shield the receptacle contacts 220 from external noise and to prevent the signals of the receptacle contacts 220 from leaking to the outside. Similarly, the present disclosure is particularly related to the second function of the receptacle shielder 240.

The receptacle shielder 240 is fabricated of a shielding material such as metal to block external noise.

The receptacle shielder 240 is preferably fabricated in a simple structure having a roughly square frame shape to surround the side peripheries of the receptacle body 210.

The receptacle shielder 240 may be divided into a shielding portion 241, cover portions 242, and a receptacle shielder mounting portion 243.

The shielding portion 241 is formed to have a height H2 in a direction approximately perpendicular to the surface S2 of the receptacle board R-PCB (the upper-lower direction in the drawing), and is provided in a square frame shape that is connected without a joint in an integrated form.

Shielding protrusions 241a are formed on the outer surfaces of the four corner areas of the shielding portion 241, respectively.

The shielding protrusions 241a are formed in areas corresponding to the power area portions 212. When the relationship with the plug shielder 140 of the plug connector 100 is taken into consideration, the shielding protrusions 241a are formed in areas corresponding to the fixed members 142a of the plug shielder 140. Accordingly, when the plug connector 100 and the receptacle connector 200 are coupled to each other, the shielding protrusions 241a of the receptacle shielder 240 come into close contact with the fixed members 142a of the plug shielder 140. Therefore, the coupling force and contact property of the plug shielder 140 and the receptacle shielder 240 are improved, so that the shielding performance can be further improved.

The cover portions 242 are formed in areas corresponding to the power area portions 212. The cover portions 242 are connected to the shielding portion 241 in an integrated form and then extended.

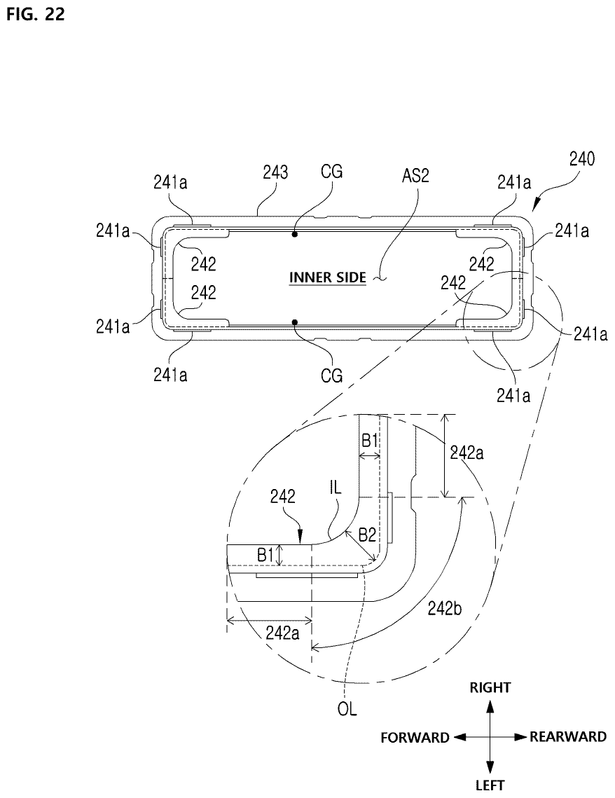

As can be seen from FIG. 21 and FIG. 22, which is a plan view, the cover portions 242 each have a structure that extends inward from the top end of the shielding portion 241 in a direction roughly parallel to the surface S2 of the receptacle board R-PCB and covers a portion of the top surface of the receptacle body 210. Accordingly, the strength of the power area portions 212 may be further reinforced by the cover portions 242.

Referring to the enlarged area of FIG. 22, the cover portions 242 each have a curved portion 242b connecting straight portions 242a adjacent at an angle of 90 degrees to each other in the corner area.

According to the present embodiment, the width B2 of the curved portion 242b is extended to be wider than the width B1 of the straight portions 242a on the horizontal plane parallel to the surface S2 of the receptacle board R-PCB to which the receptacle contacts 220 are soldered. Accordingly, the strength of the receptacle shielder 240 may be further improved at the corner points, and the strength of the receptacle body 210 may also be further reinforced. That is, the strength of the corner points, which are relatively weaker than other points in the receptacle connector 200, may be further reinforced. Accordingly, the fastening deformation that may occur at the corner points when the receptacle connector 200 and the plug connector 100 are coupled to each other may also be sufficiently prevented. Therefore, at least the largest width B2 of the curved portion 242b needs to be extended to be wider than the width B1 of the straight portions 242a.

There may be various designs that make the width B2 of the curved portion 242b wider than the width B1 of the straight portions 242a. For example, when the radius of curvature of the inner line IL of the curved portion 242b is designed to be larger than the radius of curvature of the outer line OL, the width B2 of the curved portion 242b may be made wider than the width B1 of the straight portion 242a.

The receptacle shielder 240 according to the present embodiment has checking holes CG formed between the cover portions 242. In other words, since the cover portions 242 extending from the shielding portions 241 are formed only in the corner areas, the receptacle shielder 240 has the checking holes CG formed between the cover portions 242 on the long sides in the front-rear direction. The checking holes CG are formed at corresponding positions of the signal area portion 211. Accordingly, as shown in FIG. 18, the receptacle contacts 220 installed in the signal area portion 211 are spaced apart from the receptacle shielder 240 by the checking holes CG when viewed from the plane. That is, the third checking windows CW3 described above are formed by the checking holes CG. In other words, the checking holes CG function to form the third checking windows CW3.

The receptacle shielder mounting portion 243 is mounted on the receptacle board R-PCB.

The receptacle shielder mounting portion 243 is bent from the bottom end of the shielding portion 241 in a horizontal direction parallel to the surface S2 of the receptacle board R-PCB and then extended outward. It is obvious that the receptacle shielder mounting portion 243 is connected to the shielding portion 241 in an integrated form and then extended horizontally. Accordingly, since the receptacle shielder 240 comes into contact with the receptacle board R-PCB across a wider area, the mounting area is secured accordingly, and thus, the bonding force with the receptacle board R-PCB is improved.

### Description of Features of Connecting Device

As described above, the connecting device CD according to the present disclosure includes the plug connector 100 and the receptacle connector 200.

The function of the connecting device CD is realized in such a manner that the plug connector 100 and the receptacle connector 200 are coupled to each other.

According to the present disclosure, the coupling of the plug connector 100 and the receptacle connector 200 is achieved by three fitting couplings.

A first fitting coupling is the coupling in which the plug contact contact portions 122 of the plug contacts 120 are fitted and inserted into the insertion spaces is of the receptacle contacts 220.

A second fitting coupling is the coupling in which the contact members 132a, 132b and 132c of the plug power contacts 130 are fitted and inserted into the coupling spaces JS of the receptacle power contacts 230.

A third fitting coupling is the coupling in which the receptacle shielder 240 is fitted and inserted into the inside of the plug shielder 140.

The present disclosure has a structure in which the plug contacts 120 and plug power contacts 130 of the plug connector 100 are fitted and inserted into the insertion spaces is and coupling spaces JS of the receptacle connector 200, respectively. In contrast, the receptacle shielder 240 is fitted and inserted into the inside of the plug shielder 140. This will be described in more detail.

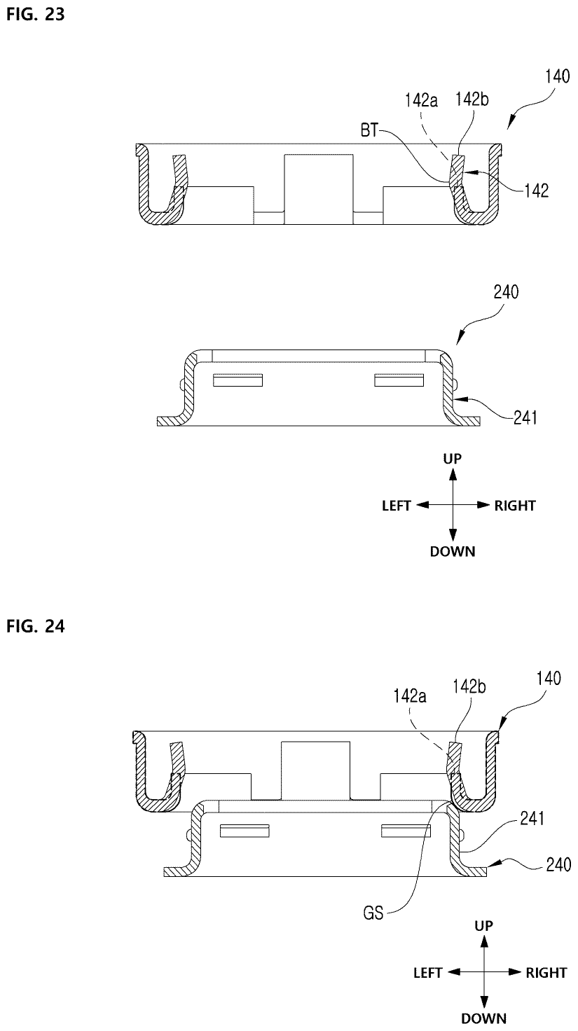

In FIG. 23, the plug shielder 140 and the receptacle shielder 240 are currently separated. For reference, in FIG. 23, the receptacle shielder 240 is positioned on the lower side, and the plug shielder 140 is positioned on the upper side. Accordingly, the upper and lower arrangement of the plug shielder 140 follows the upper and lower arrangement of FIGS. 1 and 2, unlike that of FIGS. 6 and 7.

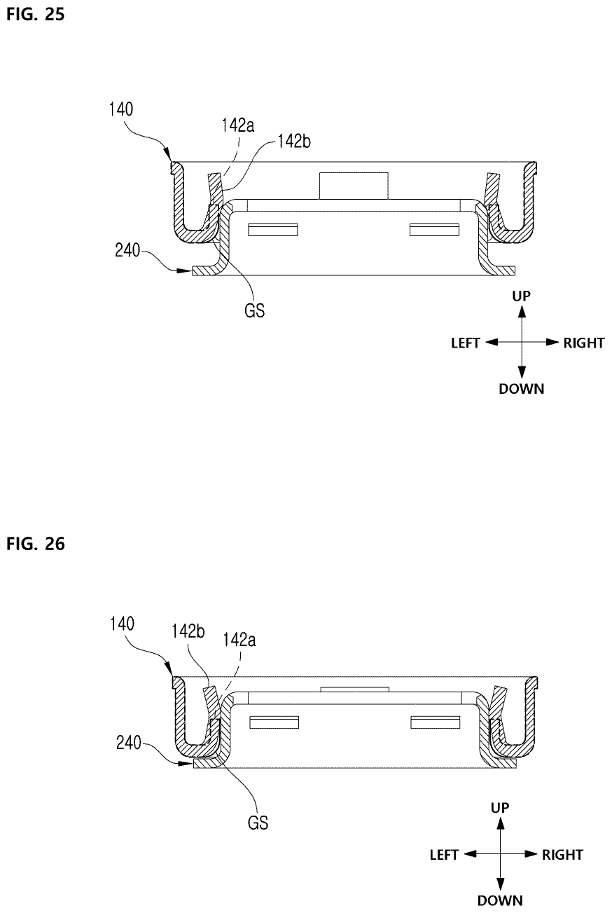

When the plug shielder 140 is lowered in the state of FIG. 23, the shielding portion 241 of the receptacle shielder 240 is inserted into the inside of the second shielding portion 142 of the plug shielder 140. In this case, as shown in FIG. 24, the top end of the shielding portion 241 of the receptacle shielder 240 first comes into contact with the fixed members 142a of the plug shielder 140. Then, in the process of lowering the plug connector 100 by further pressuring it downward, the plug shielder 140 and the receptacle shielder 240 are guided toward the coupling position thereof by the insertion guide sections GS of the fixed members 142a. Accordingly, the receptacle shielder 240 may appropriately enter the inside of the plug shielder 140. Thereafter, due to the continuous lowering of the plug connector 100, the top end of the receptacle shielder 240 comes into contact with the movable members 142b of the plug shielder 140, as shown in FIG. 25. Then, as the plug connector 100 is lowered further, the receptacle shielder 240 is fitted and inserted into the inside of the plug shielder 140, as shown in FIG. 26.

As described above, according to the present embodiment, in the process in which the plug connector 100 and the receptacle connector 200 are coupled to each other, the receptacle shielder 240 first comes into contact with the fixed members 142a of the plug shielder 140 and then comes into contact with the movable members 142b. To this end, in the present embodiment, as shown in FIGS. 23 to 26, the insertion guide sections GS present at the bottom ends of the fixed members 142a have a structure that protrudes more inward than the bottom ends of the movable members 142b in the downward direction. Through this structure, the plug connector 100 and the receptacle connector 200 may be guided through appropriate coupling.

In contrast, as shown in FIG. 23, before the plug connector 100 and the receptacle connector 200 are coupled to each other, the boundary areas BT of the movable members 142b protrude further inward than the fixed members 142a. For this reason, when the plug connector 100 is lowered while the plug shielder 140 comes into contact with the shielder contact portions 142b-2 of the movable members 142b, the movable members 142b swing, and thus, the shielder contact portions 142b-2 move outward. Furthermore, when the coupling of the plug shielder 140 and the receptacle shielder 240 is completed, the firm coupling of the plug shielder 140 and the receptacle shielder 240 is maintained by the elastic restoring force of the movable members 142b. As discussed above, the movable members 142b are spaced apart from the fixed members 142a, and the movable members 142b present on the long sides of the plug shielder 140 are also spaced apart from each other. Accordingly, the movable members 142b are capable of performing swinging motion that allows for elastic return. This enables the minimization of the pressing force required when the plug connector 100 and the receptacle connector 200 are coupled to each other.

In addition, in the present embodiment, the structure in which the receptacle shielder 240 of the receptacle connector 200 is inserted into the inside of the plug shielder 140 of the plug connector 100 has a special effect. The corresponding structure needs to be discussed in conjunction with the coupling structure of the plug contacts 120 and the receptacle contacts 220.

As mentioned above, the plug contacts 120 and the receptacle contacts 220 are coupled to each other in such a manner that the plug contact contact portions 122 of the plug contacts 120 are fitted and inserted into the insertion spaces is of the receptacle contacts 220. Accordingly, in terms of such a coupling structure, the width W2 of the receptacle contacts 220 needs to be wider than the width W1 of the plug contactors 120. Accordingly, by adopting a coupling structure in which the receptacle shielder 240 is fitted and inserted into the inside of the plug shielder 140, the increase in the overall width of the connecting device CD may be minimized. However, the present disclosure is not necessarily limited to the structure in which the receptacle shielder 240 is inserted into the inside of the plug shielder 140. For example, the structure of the plug shielder 140 and the structure of the receptacle shielder 240 may be interchanged with each other, which will be described under a separate section title.

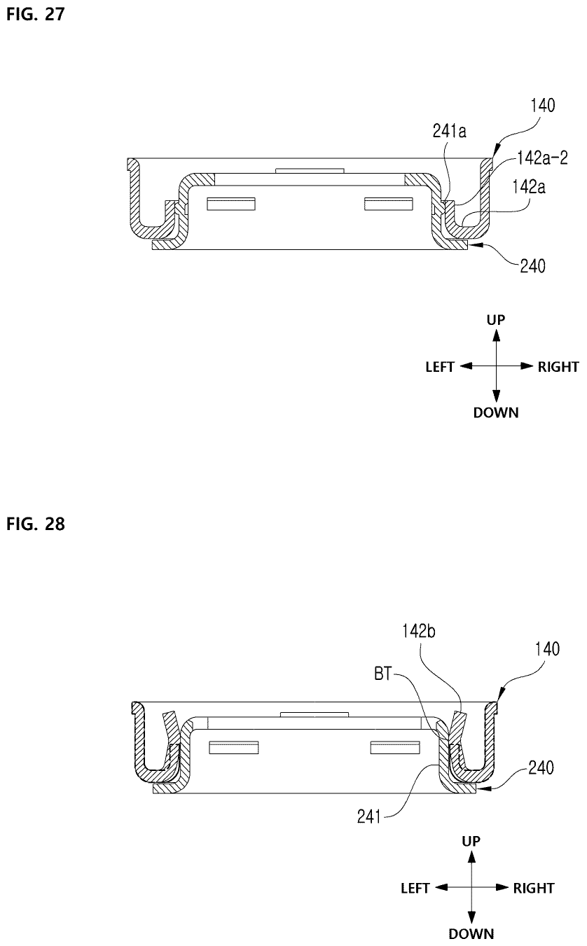

Meanwhile, when the state of FIG. 26 in which the coupling of the plug connector 100 and the receptacle connector 200 is completed is entered, the coupling states in two characteristic areas will be discussed with reference to FIGS. 27 and 28.

First, the sectional view of FIG. 27 shows an area where the fixed members 142a are present. From FIG. 27, it can be seen that the shielding protrusions 241a of the receptacle shielder 240 are in close contact with the fixed members 142a of the plug shielder 240. More specifically, from FIG. 27, it can be seen that the shielding protrusions 241a of the receptacle shielder 240 are in close contact with the spaced extension portions 142a-2 of the plug shielder 140.

In addition, the sectional view of FIG. 28 shows an area where the movable members 142b are present. From FIG. 28, it can be seen that the shielding portion 241 of the receptacle shielder 240 is in close contact with the movable member 142b of the plug shielder 140. More specifically, from FIG. 28, it can be seen that the shielding portion 241 of the receptacle shielder 240 is in close contact with the boundary area BT of the movable member 142b of the plug shielder 140.

According to the present disclosure, external noise is primarily blocked in the first shielding portion 141 of the plug shielder 140, and external noise is secondarily blocked in the second shielding portion 142. Furthermore, external noise is tertiarily blocked in the shielding portion 241 of the receptacle shielder 240. That is, in the present disclosure, a double shielding structure is introduced to the plug shielder 140 as a whole, and the receptacle shielder 240 is added, so that a triple shielding structure is adopted when the plug connector 100 and the receptacle connector 200 are coupled to each other. Accordingly, the plug contacts 120 and the receptacle contacts 220 are triply shielded from external noise. Furthermore, as shown in FIGS. 27 and 28, the contact area between the plug shielder 140 and the receptacle shielder 240 is increased, so that external noise that may leak into the gap between the plug shielder 140 and the receptacle shielder 240 is blocked to the maximum extent.

It is obvious that the plug shielder 140 and the receptacle shielder 240 also prevent the field (the electromagnetic field), generated by the connecting device CD, from leaking out to the outside. Accordingly, there is also prevented the phenomenon in which the field generated by the connecting device CD distorts the signal transmitted through an outside circuit.

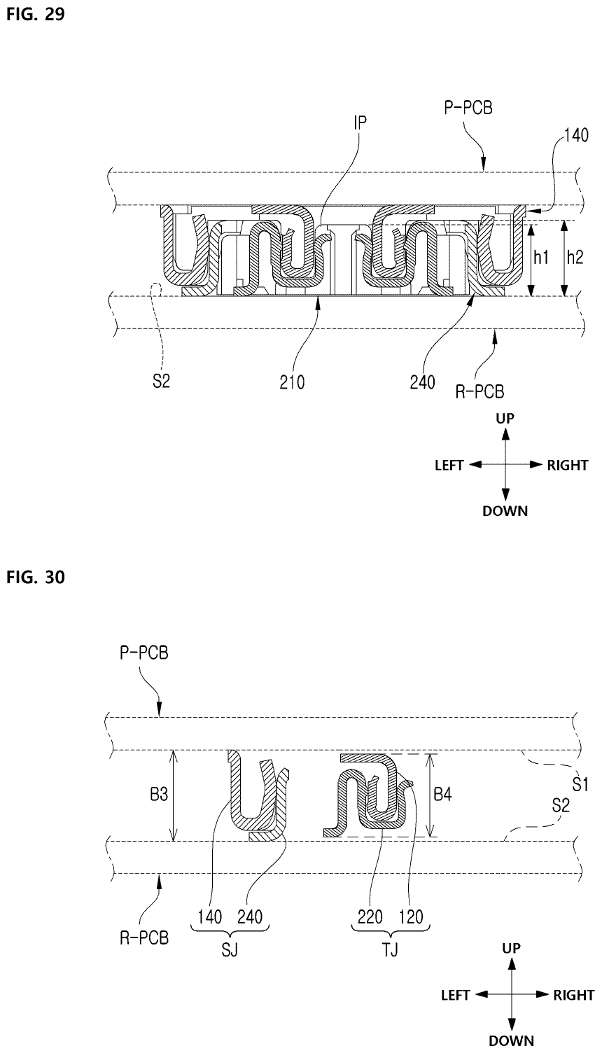

Finally, FIG. 29 shows a state in which the connecting device CD is coupled to the plug board P-PCB and the receptacle board R-PCB.

Referring to FIG. 29, it can be seen that the top end of the plug shielder 140 of the connecting device CD is mounted on the plug board P-PCB to which the plug contacts 120 are soldered, and the receptacle shielder mounting portion 243 constituting the bottom end of the receptacle shielder 240 is mounted on the receptacle board R-PCB to which the receptacle contacts 220 are soldered. Accordingly, the plug contacts 120 and the receptacle contacts 220 may be almost completely shielded from external noise by the plug shielder 140 and the receptacle shielder 240. In connection with this, the following description will be further made from another perspective with reference to FIG. 30, which is schematically illustrated in an exaggerated manner.

In FIG. 30, the upper-lower width B3 of a shielder coupled body SJ in which the plug shielder 140 and the receptacle shielder 240 are coupled to each other is the same as or at least slightly wider than the upper-lower width B4 of a contact coupled body TJ in which the plug contact 120 and the receptacle contact 220 are coupled to each other. Accordingly, the contact coupled body TJ is disposed within the width B3 of the shielder coupled body SJ. That is, the top end of the contact coupled body TJ is lower than or has at least the same height as the top end of the shielder coupled body SJ, and the bottom end of the contact coupled body TJ is higher than or has at least the same height as the bottom end of the shielder coupled body SJ. More specifically, the top end of the plug shielder 140 is higher than or has at least the same height as the top end of the plug contact 120, and the bottom end of the receptacle shielder 240 is lower than or has at least the same height as the bottom end of the receptacle contact 220.

Accordingly, the contact portions 122 and 222 of the contact coupled body TJ are confined in the inner arrangement space AS1 or AS2 of the shielder coupled body SJ in the horizontal direction parallel to the surfaces S1 and S2 of the plug board P-PCB and the receptacle board R-PCB. In other words, the contact portions 122 and 222 at the top and bottom ends of the contact coupled body TJ are not exposed to the outside in the horizontal direction parallel to the surfaces S1 and S2 of the plug board P-PCB and the receptacle board R-PCB. Furthermore, this means that the contacts 120 and 220 of the connecting device CD are shielded from the field (the noise) formed in other circuits on the plug board P-PCB or the receptacle board R-PCB.

Meanwhile, referring to FIGS. 7 and 8, etc, the checking windows having the reference symbol CW2a out of the second checking windows CW2a and CW2b of the plug body 110 are formed to be open to the outside. Accordingly, the two straight sections SB1 that are adjacent to each other while being disposed in different corner areas are cut by the second checking window CW2a. In other words, the two adjacent straight sections SB1 are spaced apart from each other by the second checking window CW2a. This structure enables the machining error of the plug body 110 and the receptacle body 210 to be overcome. For example, when there is a machining error in the plug body 110 and the receptacle body 210, a large insertion resistance may occur when the plug connector 100 and the receptacle connector 200 are coupled to each other. In this case, the second checking windows CW2a open to the outside generate widening deformation that causes elastic expansion in the left-right direction, thereby enabling the plug connector 100 and the receptacle connector 200 to be appropriately and easily coupled to each other.

Referring to FIG. 29 again, it can be seen that the height h2 of the receptacle shielder 240 is higher than the height h1 of the insertion protrusion IP. In other words, assuming that the receptacle connector 200 is coupled to the receptacle board R-PCB, there is provided the structure in which the top end height h2 of the receptacle shielder 240 is higher than the top end height h1 of the insertion protrusion IP on the top surface S2 of the receptacle board R-PCB. In other words, the top end of the insertion protrusion IP is lower than the top end of the receptacle shielder 240, so that it does not protrude upward above the top end of the receptacle shielder 240. According to this structure, the receptacle body 210, which is an insulating non-metallic object, does not protrude above the receptacle shielder 240, and thus, is prevented from being damaged by interference or the like. That is, the receptacle shielder 240 also has a function of protecting the receptacle body 210.

### Description of Modified Examples

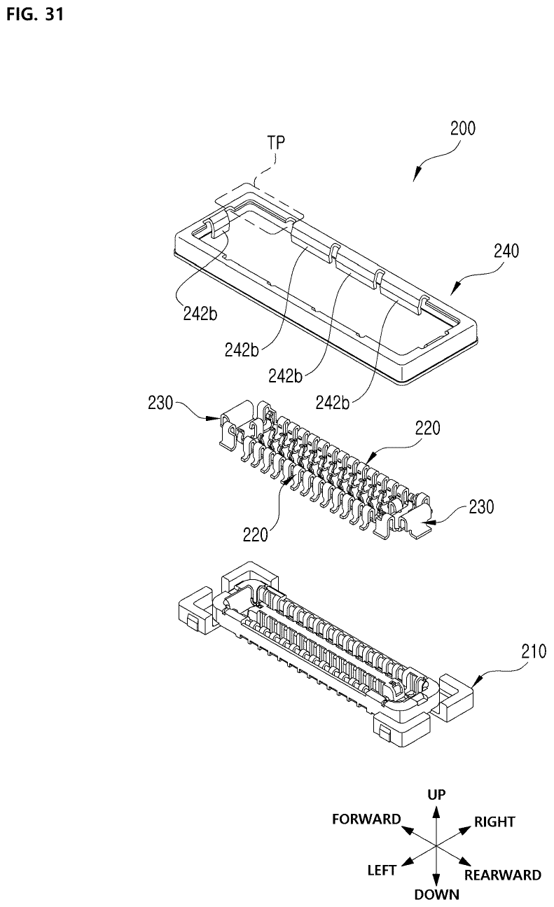

As described above, in order to minimize the connecting device CD, the plug shielder 140 equipped with the movable members 142b is provided in the plug connector 100. However, depending on the implementation, a receptacle connector 200 illustrated in the exploded view of FIG. 31 may also be sufficiently considered.

In the case of the receptacle connector 200 of FIG. 31, it also has a receptacle body 210, receptacle contacts 220, receptacle power contacts 230, and a receptacle shielder 240. In this case, the functions of the receptacle body 210, the receptacle contacts 220, and the receptacle power contacts 230 are the same as those described in the previous embodiments, so that detailed descriptions thereof will be omitted.

The receptacle connector 200 according to the modified example of FIG. 31 has the receptacle shielder 240 including movable members 242b. That is, the receptacle shielder 240 of the receptacle connector 200 of FIG. 31 has a shape and structure that are almost the same as those of the plug shielder 140 shown in FIG. 11.

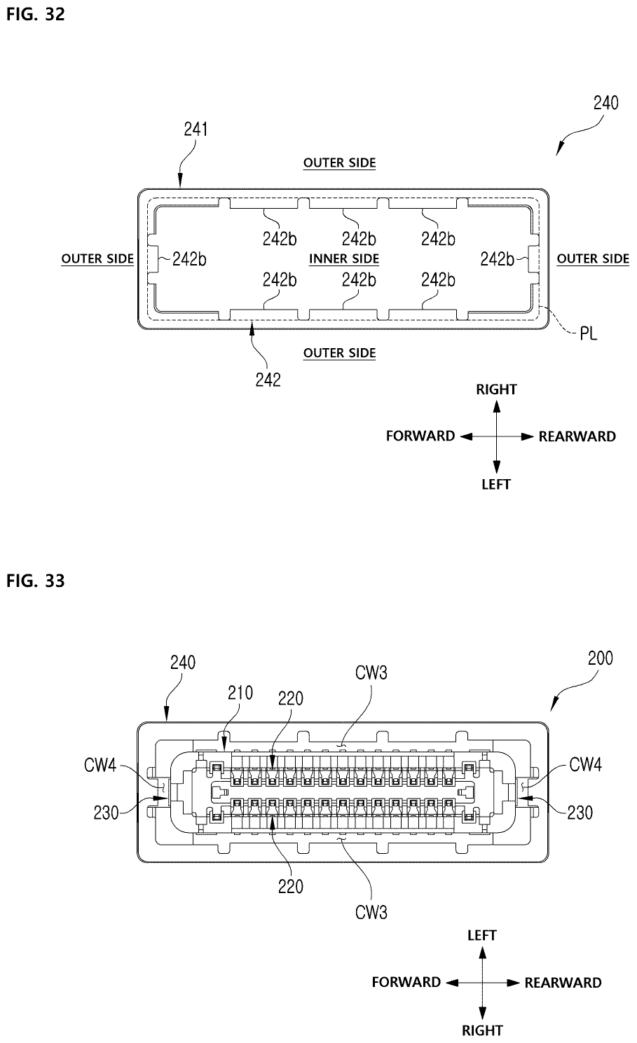

Accordingly, as shown in the plan view of FIG. 32, the receptacle shielder 240 has a first shielding portion 241 on the outside thereof and a second shielding portion 242 on the inside thereof based on an arbitrary dotted line PL.

The first shielding portion 241 surrounds the periphery of the receptacle body 210, and shields the receptacle contacts 220 from external noise.

The second shielding portion 242 is formed by extending from the first shielding portion 241 in an integrated form.

The second shielding portion 242 is disposed inside the first shielding portion 241, and blocks external noise along with the first shielding portion 241 in a double manner.

In the same manner, the second shielding portion 242 has movable members 242b capable of swinging.

However, as for the deformation area TP of FIG. 31 in more detail, the receptacle shielder 240 does not have the spaced extension portion 142a-2 of the fixed member 142a unlike the plug shielder 140 shown in FIG. 13. Accordingly, the receptacle shielder 240 of FIG. 31 does not have separate coupling depressions formed to be coupled to the receptacle body 210. In this case, the receptacle body 210 and the receptacle shielder 240 may be coupled by the fitting force between the edge of the receptacle body 210 and the inner surface of the first shielding portion 241. However, in the modified example of FIG. 31, for more desirable coupling force between the receptacle body 210 and the receptacle shielder 240, it may be desirably contemplated that the receptacle body 210 is injection-molded in the state in which the receptacle shielder 240 has been inserted.

FIG. 33 is a bottom view of the receptacle connector 200 of FIG. 31.

Referring to FIG. 33, third checking windows CW3 are formed between the receptacle body 210 and the receptacle shielder 240. Accordingly, an inspector may check the soldering states between the receptacle contacts 220 and the receptacle board R-PCB on a plane surface through the third checking windows CW3.

In addition, fourth checking windows CW4 are formed in the receptacle body 210. Accordingly, an inspector may check the soldering states between the receptacle power contacts 230 and the receptacle board R-PCB on a plane surface through the fourth checking windows CW4. It is obvious that the fourth checking windows CW4 are also partitioned from the third checking windows CW3 by the receptacle body 210.

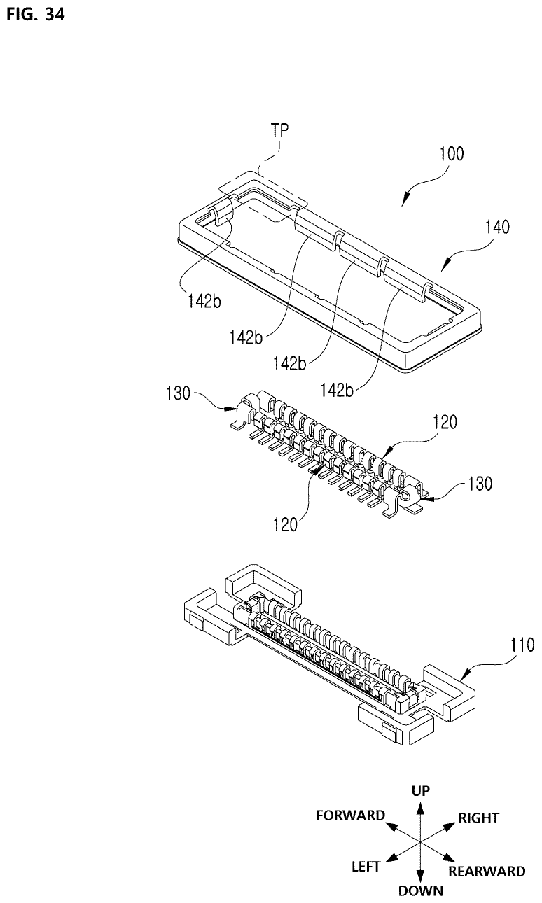

Meanwhile, the structure of the deformation area TP of FIG. 31 may also be applied to the case of the plug shielder 140 equipped with the movable members 142b of FIG. 11, and this will be discussed with reference to FIG. 34.

FIG. 34 shows a plug connector 100 according to a modification of FIG. 7.

As shown in FIG. 34, the plug connector 100 includes a plug body 110, plug contacts 120, plug power contacts 130, and a plug shielder 140 having movable members 142b.

In the same manner, as in FIG. 34, the structure of the deformation area TP of the plug connector 100 does not have a separate spaced extension portion 142a-2 unlike in the plug shielder 140 of FIG. 11. Accordingly, the plug shielder 140 according to the deformation of FIG. 34 does not have separate coupling depressions formed to be coupled to the plug body 110. In this case, it may be desirable to make an implementation so that the plug body 110 is injected in the state in which the plug shielder 140 has been inserted.

### Additional Description of Coupling of Body and Shielder

The coupling of the body 110 or 210 and the shielder 140 or 240 may be performed by at least two methods according to the implementation.

For example, the body 110 or 210 and the shielder 140 or 240 may be coupled to each other by insert injection. That is, when the body 110 or 210 is injected, injection molding may be performed after not only the contacts 120 or 220 and the power contacts 130 or 230 but also the shielder 140 or 240 have been inserted into a mold. Then, the body 110 or 210, the contacts 120 or 220, the power contacts 130 or 230, and the shielder 140 or 240 are coupled together as one module. In this case, the body 110 or 210 is coupled with the shielder 140 or 240 only in the power area portions 112 or 212. However, since the coupling is made in both the curved sections RB1 or RB2 and the two straight sections SB1 or SB2, the coupling between the body 110 or 210 and the shielder 140 or 240 may be maintained firmly.

For example, the body 110 or 210 and the shielder 140 or 240 may be coupled to each other by fitting insertion coupling. In this case, in the state in which the body 110 or 210, the contacts 120 or 220, and the power contacts 130 or 230 are coupled into a single module by insert injection, the shielder 140 or 240 is fitted and inserted into the body 110 or 210. Even in this fitting insertion coupling method, the coupling force between the shielder 140 or 240 and the body 110 or 210 needs to be maintained. Accordingly, the configuration of close contact protrusions configured to increase the close contact force between the shielder 140 or 240 and the body 110 or 210 may be preferably contemplated.

According to a preferred example, as shown in FIGS. 7 and 16, the close contact protrusions AP1 or AP2 are formed on the body 110 or 210.

In the plug body 110, the close contact protrusions AP1 are formed on the lower sides of the coupling portions 112a. More specifically, the close contact protrusions AP1 are formed on the sides of the straight sections SB1 rather than the curved sections RB1. When the close contact protrusions AP1 are formed on the straight sections SB1, the tolerance at the corner points of the plug body 110 and the plug shielder 140 may be sufficiently secured at the corner points. Accordingly, the assembly between the plug body 110 and the plug shielder 140 may also be improved.

For the same reason, it is desirable to form close contact protrusions AP2 on the straight sections SB2 in the receptacle body 210.

The above-described embodiments are merely described as preferred examples of the present disclosure, and may have various application forms. Therefore, the present disclosure should not be understood as being limited to the content described above. Instead, the scope of the rights of the present disclosure should be understood based on the separately described claims and their equivalents.

What is claimed is:

1. A plug connector comprising:
a plug body formed of a non-conductive material;
plug contacts fixedly installed to the plug body, and configured to come into contact with receptacle contacts of a receptacle connector;
a pair of plug power contacts coupled to the plug body, and configured to come into contact with receptacle power contacts present in the receptacle connector; and
a plug shielder configured to shield the plug contacts from external noise;
wherein the plug body comprises:
a signal area portion in which the plug contacts are installed; and
a pair of power area portions which are arranged to protrude further from both ends of the signal area portion, and in which the plug power contacts are installed;
wherein the plug shielder has a structure that surrounds a periphery of the plug body while forming an arrangement space in which the plug contacts and the pair of plug power contacts are arranged therein; and
wherein the plug shielder is coupled to the pair of power area portions.

2. The plug connector of claim 1, wherein the plug body and the plug shielder are not coupled to each other in the signal area portion.

3. The plug connector of claim 1, wherein the plug shielder comprises:
a first shielding portion that surrounds a periphery of the plug body and shields the plug contacts from external noise; and
a second shielding portion that is disposed inside the first shielding portion and blocks external noise along with the first shielding portion in a double manner; and
wherein the second shielding portion is formed by extending from the first shielding portion in an integrated form.

4. The plug connector of claim 3, wherein the second shielding portion has movable members capable of swinging.

5. The plug connector of claim 4, wherein a plurality of movable members are arranged on each long side of the plug shielder.

6. The plug connector of claim 3, wherein the second shielding portion comprises:
fixed members formed to be fixedly coupled with the plug body; and
movable members spaced apart from the fixed members;
wherein the fixed members are formed by extending from corner areas of the first shielding portion each having a square frame shape;
wherein the movable members are arranged between the corner areas; and
wherein the fixed members each have two straight sections adjacent to each other and arranged at an angle of 90 degrees, and a curved section connecting the two straight sections between the two straight sections.

7. The plug connector of claim 6,
wherein coupling portions to which the plug shielder is coupled are formed in an edge area of each of the pair of power area portions;
wherein the coupling portions each have two straight sections adjacent to each other and arranged at an angle of 90 degrees, and a curved section connecting the two straight sections between the two straight sections; and
wherein the two straight sections of the fixed member are coupled to correspond to the two straight sections of the coupling portion, and the curved section of the fixed member is coupled to correspond to the curved section of the coupling portion.

8. The plug connector of claim 7, wherein the coupling portions are each formed by extending from a bottom surface that extends outward from the plug power contact.

9. The plug connector of claim 1, wherein a plurality of checking windows for checking soldering states between the plug power contacts and a plug board are formed in each of the pair of power area portions.

10. The plug connector of claim 9, wherein one of the plurality of checking windows is formed to be open to an outside, thereby spacing the adjacent straight sections apart from each other.

11. A receptacle connector comprising:
a receptacle body formed of a non-conductive material;
receptacle contacts fixedly installed to the receptacle body, and coupled with plug contacts of a plug connector;
a pair of receptacle power contacts fixedly installed to the receptacle body, and configured to come into contact with plug power contacts present in the plug connector; and
a receptacle shielder configured to shield the receptacle contacts from external noise;
wherein the receptacle body comprises:
a signal area portion in which the receptacle contacts are installed; and
a pair of power area parts which are arranged to protrude further from both ends of the signal area portion, and in which the receptacle power contacts are installed;
wherein the receptacle shielder has a structure that surrounds a periphery of the receptacle body while forming an arrangement space in which the receptacle contacts and the pair of receptacle power contacts are arranged therein; and
wherein the receptacle shielder is coupled to the pair of power area portions.

12. The receptacle connector of claim 11, wherein the receptacle body and the receptacle shielder are not coupled to each other in the signal area portion.

13. The receptacle connector of claim 11, wherein the receptacle shielder comprises:
a shielding portion that surrounds a periphery of the receptacle body and shields the receptacle contacts from external noise; and
cover portions that are formed by extending inward from corner areas of the shielding portion and cover portions of a top side of the receptacle body.

14. The receptacle connector of claim 13,
wherein the cover portions each have a curved portion connecting both straight portions adjacent to each other and arranged at an angle of 90 degrees at a corner point; and
wherein on a horizontal plane parallel to a surface of a receptacle board to which the receptacle contacts are soldered, a largest width of the curved portion is extended to be wider than a width of the straight portions.

15. The receptacle connector of claim 11, wherein the receptacle shielder has checking holes configured to form checking windows for checking soldering states between a receptacle board and the receptacle contacts.

16. The receptacle connector of claim 15, wherein the receptacle shielder comprises:
a shielding portion that surrounds a periphery of the receptacle body and shields the receptacle contacts from external noise; and
cover portions that are formed by extending inward from corner areas of the shielding portion and cover portions of a top side of the receptacle body; and
wherein the checking holes are formed between the cover portions.

17. A receptacle connector comprising:
a receptacle body formed of a non-conductive material;
receptacle contacts fixedly installed to the receptacle body, and coupled with plug contacts of the plug connector;
a pair of receptacle power contacts coupled to the receptacle body, fixed to a receptacle board by soldering, and arranged on both front and rear sides of the receptacle body; and
a receptacle shielder configured to shield the receptacle contacts from external noise, and having a structure that surrounds a periphery of the receptacle body while forming an arrangement space in which the receptacle contacts and the pair of receptacle power contacts are arranged therein;
wherein the receptacle shielder comprises:
a first shielding portion which surrounds the periphery of the receptacle body and shields the receptacle contacts from external noise; and
a second shielding portion which is formed by extending from the first shielding portion in an integrated form, is disposed inside the first shielding portion and blocks external noise along with the first shielding portion in a double manner; and
wherein the second shielding portion has movable members capable of swinging.

18. The receptacle connector of claim 17, wherein third checking windows configured to check soldering states between the receptacle contacts and a receptacle board are formed between the receptacle body and the receptacle shielder.

19. The receptacle connector of claim 18,
wherein fourth checking windows configured to check soldering states between the receptacle power contacts and the receptacle board are formed in the receptacle body; and
wherein the fourth checking windows are partitioned from the third checking windows by the receptacle body.

20. The receptacle connector of claim 17,
wherein the receptacle body has a long insertion protrusion in a front-rear direction;
wherein the receptacle contacts are divided into and installed in two left and right rows with the insertion protrusion interposed therebetween; and
wherein a height of the receptacle shielder is higher than a height of the insertion protrusion.
